(19) United States
(12) Patent Application Publication
(10) Pub. No.: US 2026/0275236 A1
(43) Pub. Date: Sep. 17, 2026

(54) SELF PRESERVED MILD LIQUID LAUNDRY DETERGENT FORMULAS WITH LOW PH

(71) Applicant: Henkel AG & Co. KGaA, Duesseldorf (DE)

(72) Inventor: Daniel Thomas Piorkowski, Fairfield, CT (US)

(73) Assignee: Henkel AG & Co. KGaA, Duesseldorf (DE)

(21) Appl. No.: 19/436,371

(22) Filed: Dec. 30, 2025

Related U.S. Application Data
(60) Provisional application No. 63/773,279, filed on Mar. 17, 2025.

(51) Int. Cl. C11D 1/831; C11D 3/04; C11D 3/20; C11D 3/33

(52) U.S. Cl. CPC C11D 1/831; C11D 3/044; C11D 3/2086; C11D 3/33

(57) ABSTRACT

The present disclosure provides a mild, self-preserving liquid detergent composition that comprises a combination of materials such as solvents, salts, pH, and surfactants in varying ratios to overcome potential bacteria or fungal growth in the detergent product while maintaining a good cleaning performance. The detergent composition of the present disclosure does not comprise a preservative, has a pH of less than 5, and has a Zein score of not more than about 2% dissolved zein when tested on a 10% dilution.

### BACKGROUND

Laundry detergent compositions contain surfactants which impart good cleaning performance. However, many surfactant compositions can cause skin and eye irritation. Preferred surfactants for efficacy have included the anionic linear alkylbenzene sulfonates (LAS) that can be a harsh additive to detergent compositions, and replacements such as alcohol ethoxysulfonates can contain traces of regulated compounds. Further, solvents included in detergent compositions can be allergens. Propylene glycol was named the 2018 allergen of the year by the American Contact Dermatitis Society.

Water-based products, like liquid laundry detergents, are prone to growing mold and bacteria. To avoid this and keep products safe and effective, liquid detergents need to have added preservatives. However, these preservatives can cause irritation, itching, and redness, particularly in people with sensitive skin.

There is a need for a self-preserved liquid laundry detergent product that can effectively clean textiles while retaining mildness and limiting allergenic compounds.

### BRIEF SUMMARY

The present disclosure relates to a detergent composition comprising water, about 15 to about 25 wt % of surfactant, about 0.1 to about 1.25 wt % of a fatty acid, about 0.5 to about 2 wt % of polymer and a chelant, and optionally about 2 to about 12 wt % of at least one ingredient selected from the group consisting of ethanol and NaCl, wherein the surfactant consists essentially of a single anionic surfactant and a single non-ionic surfactant, wherein the detergent composition does not comprise a preservative, wherein the detergent composition has a pH of less than 5, and wherein the detergent composition has a Zein score of not more than about 2% dissolved zein when tested on a 10% dilution.

In some aspects, the composition has a pH of about 2 to about 4.5. In some aspects, the composition has a pH of about 2 to about 3.5.

In some aspects, the single anionic surfactant is present in an amount of about 5 wt % to about 8 wt % and the single non-ionic surfactant is present in an amount of about 10 wt % to about 12 wt %

In some aspects, the single anionic surfactant and single non-ionic surfactant are present in an amount ratio of 1:2.

In some aspects, the single anionic surfactant is an alkyl ether sulfate. In some aspects, the alkyl ether sulfate is lauryl ether sulfate.

In some aspects, the single non-ionic surfactant is an alcohol ethoxylate. In some aspects, the non-ionic alcohol ethoxylate comprises the formula R¹-(EO)ₙ—OH, wherein R¹ is a C₁₂-C₁₈ alkyl group, EO is ethoxylate, and n is an integer of moles from 1 to 15.

In some aspects, the detergent composition comprises about 2 to about 10 wt % of ethanol.

In some aspects, the detergent composition comprises about 2 to about 10 wt % of NaCl.

In some aspects, the polymer is selected from a polyethyleneimine alkoxylate, a methylacrylate styrene copolymer, an acrylic acid polymer, and combinations thereof.

In some aspects, the chelant is methylglycinediacetic acid (MGDA).

In some aspects, the detergent composition further comprises at least one additive selected from an acid, a base, an amino acid, a chlorine scavenger, an optical brightener, a fragrance, one or more enzymes, a corrosion inhibitor, and combinations thereof.

In some aspects, the detergent composition comprises an acid and a base to form a buffer. In some aspects, the acid is citric acid and the base is NaOH.

In some aspects, the detergent composition has a Zein score of not more than about 1% dissolved zein when tested on a 10% dilution.

In some aspects, the detergent composition has a greater than 1 log reduction on day 14 in a micro challenge for yeast and mold. In some aspects, the detergent composition has a greater than 1 log reduction on day 28 in a micro challenge for bacteria, yeast and mold.

In some aspects, the detergent composition has a viscosity of about 200 to about 1500 cP at 25° C.

In some aspects, the composition comprises about 15 to about 20 wt % of a non-ionic alcohol ethoxylate and an alkyl ether sulfate, about 0.2 to about 0.3 wt % of fatty acid, about 0.5 to about 1 wt % of a polymer and a chelant, and citric acid, wherein the detergent composition has a pH of about 2 to about 4.5.

### DETAILED DESCRIPTION

Provided herein is a detergent composition comprising water, about 15 to about 25 wt % of surfactant, about 0.1 to about 1.25 wt % of a fatty acid, about 0.5 to about 2 wt % of polymer and a chelant, and optionally about 2 to about 12 wt % of at least one ingredient selected from the group consisting of ethanol and NaCl, wherein the surfactant consists essentially of a single anionic surfactant and a single non-ionic surfactant, wherein the detergent composition does not comprise a preservative, wherein the detergent composition has a pH of less than 5, and wherein the detergent composition has a Zein score of not more than about 2% dissolved zein when tested on a 10% dilution.

Non-limiting examples of the various aspects are shown in the present disclosure.

### Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number ±10%. For example, “about 10” means 9 to 11.

The phrase “substantially free of” means that a composition contains little to none of the specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one enzyme” means that 1, 2, 3, or more enzymes are included in the detergent composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant figures).

Unless states otherwise, the term “by weight of the composition” refers to a composition of a final product derived from a process, unless otherwise defined.

The terms “process” and “method” can be used interchangeably.

The terms “alkoxylate” or “alkoxylated” as used in the present application means: the presence of an polyaliphatic ether moiety in a compound, such as ethoxylate (—CH₂CH₂O—) or propoxylate (—CH(CH₃)CH₂O—). A polyethoxylate is multiple repeat units of ethoxylate ((—CH₂CH₂O—)ₙ), and a polypropoxylate is multiple repeat units of propoxylate ((—CH(CH₃)CH₂O—)ₘ). The subscripts “n” and “m” are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The terms “ethoxylate” or “ethoxylated” as used in the present application means the presence of multiple repeat units of ethoxylate ((—CH₂CH₂O—)ₙ). The subscript “n” is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The term “Zein score” or “Zein number” as used in the present application refers to a score or number measured using a Zein test (see, e.g. US 2018/0016523), as described in the examples. A Zein test determines the extent of denaturation of Zein corn protein after exposure to a surfactant for a given period of time. Generally, the higher the Zein score, the greater the skin irritation potential.

In some aspects, the detergent compositions described herein have a Zein score of less than about 2% dissolved zein when tested at a 10% dilution. In other aspects the detergent compositions described herein have a Zein score of less than 1% dissolved zein when tested at a 10% dilution. The protocol can also be run on a detergent composition tested at a 10% dilution. In other aspects, the detergent compositions described herein at a 10% dilution have a Zein score of from about 0.01% to about 2%, from about 0.01% to about 1.75%, about 0.01% to about 1.5%, or about 0.01% to about 1.25%, or about 0.01% to about 1% dissolved zein.

The term “water activity” as used in the present application is often referred to as the “free” or “available water” in a system and is a measure of how efficiently the water present in a system can take part in a reaction or in a physical process. Water activity (a_{w}) is a dimensionless parameter defined as the vapor pressure of water in a system (p) divided by that of pure water at the same temperature (pₒ). It correlates with the proportion of water available for biological or chemical reactions and is related to the energy status of the water molecules in a given system. Pure distilled water has a water activity of 1. For example, a water activity of 0.80 means the vapor pressure is 80% of that of pure water.

### Detergent Composition

In some aspects, the present disclosure is directed to a detergent composition comprising water, about 15 to about 25 wt % of surfactant, about 0.1 to about 1.25 wt % of a fatty acid, about 0.5 to about 2 wt % of polymer and a chelant, and optionally about 2 to about 12 wt % of at least one ingredient selected from the group consisting of ethanol and NaCl, wherein the surfactant consists essentially of a single anionic surfactant and a single non-ionic surfactant, wherein the detergent composition does not comprise a preservative, wherein the detergent composition has a pH of less than 5, and wherein the detergent composition has a Zein score of not more than about 2% dissolved zein when tested on a 10% dilution.

Mildness is a significant consumer need and driver for laundry detergent purchase. There are several methods to measure the skin irritancy potential of a surfactant composition, such as the testing methods as described in US 2018/0016523, the entire disclosure of which is incorporated herein by reference. These tests include Zein, Corneosufametry, and Cytokine testing. The aggregate of these scores can be used to determine the mildness of a detergent for consumers.

It was discovered that a mild composition (i.e., a composition with a low Zein score) could be provided with a detergent composition with a low pH comprising mild surfactants at specific ratios. In some aspects, the detergent composition has a Zein score that is not more than 2% dissolved zein when tested on a 10% dilution of the detergent composition when measured in accordance with the method set forth herein and in US 2018/0016523, the disclosure of which is incorporated herein by reference in its entirety. In some aspects, the detergent composition has a Zein score of not more than 1% dissolved zein when tested on a 10% dilution. In other aspects, the detergent composition has a Zein score of from about 0.01% to 2%, from about 0.01% to about 1.75%, about 0.01% to about 1.5%, or about 0.01% to about 1.25%, or about 0.01% to about 1% dissolved zein, when measured at a 10% dilution.

In some aspects, the detergent composition comprises water in any amount that is sufficient to bring the total weight of the composition to 100 wt % (q.s.).

The detergent composition can have any suitable viscosity. In some aspects, the detergent composition has a viscosity about 75 to 1500 times greater than the viscosity of water at room temperature (i.e., about 20° C.). In some aspects, the detergent composition has a viscosity of about 75 to about 1500 cP e.g., about 75 to about 1500 cP, about 75 to about 1400 cP, about 75 to about 1300 cP, about 75 to about 1200 cP, about 75 to about 1100 cP, about 75 to about 1000 cP, about 75 to about 900 cP, about 75 to about 800 cP, about 75 to about 700 cP, about 75 to about 600 cP, about 75 to about 500 cP, about 75 to about 400 cP, about 75 to about 300 cP, about 75 to about 200 cP, about 75 to about 100 cP, about 75 cP, about 100 cP, about 200 cP, about 300 cP, about 400 cP, about 500 cP, about 600 cP, about 700 cP, about 800 cP, about 900 cP, about 1000 cP, about 1100 cP, about 1200 cP, about 1300 cP, about 1400 cP or about 1500 cP, at room temperature (i.e., about 20° C.). In some aspects, the detergent composition has a viscosity of about 200 cP or about 350 cP. In some aspects, the detergent composition has a viscosity of about 550 cP or about 1050 cP. In some aspects, the detergent composition has a viscosity of about 200 to about 1500 cP at 25° C.

In some aspects, preservation of the detergent composition is controlled by water activity and the use of salts and solvents. Water activity is a measure of the freely available water in a material and indicates the availability of the water for chemical, biochemical and microbial reactions and processes. Water activity is stated as an a_{w} value and is defined as the quotient of the concentration of water in the vapor phase in the airspace over the material and the water concentration in the airspace over pure water at a specific temperature:

$${a}_{w} = \begin{matrix}p \\ \to \\ {p}_{o}\end{matrix}$$

In general, the water activity can be lowered by increasing the amount of non-aqueous solvent relative to the amount of water. It was surprisingly found that compositions with relatively high water activity were still capable of preventing microbial reactions. In some aspects, the detergent composition has a water activity of about 0.90 to about 1. For example, the water activity can be about 0.90 to about 1, about 0.91 to about 1, about 0.92 to about 1, about 0.93 to about 1, about 0.94 to about 1, about 0.95 to about 1, about 0.96 to about 1, about 0.97 to about 1, about 0.98 to about 1, or about 0.99 to about 1. In some aspects, the detergent composition has a water activity of about 0.95 to about 1 (e.g., about 0.99, about 0.98, about 0.97, about 0.96, or about 0.95).

Preservative free products may be viewed favorably by consumers as some preservatives may cause skin irritation or be viewed negatively by consumers. The present disclosure is directed to self-preserving detergent formulations. In lieu of using a preservative, self-preservation is achieved by utilizing a combination of materials such as salt, solvent, acid, and pH, among others, as a way to overcome potential bacteria or fungal growth in the detergent product.

In some aspects, the detergent composition does not comprise a preservative (e.g., an added preservative) or a biocide, which is any suitable compound with antimicrobial (e.g., antibacterial, antiviral, antifungal) activity.

In some aspects, preservation of the detergent composition is controlled by the use of solvents, salts, pH, and surfactants in varying ratios to prevent the growth of bacteria and fungi as determined by a microbial challenge. A microbial challenge study is a laboratory study in which a product is artificially-inoculated with pertinent pathogenic or spoilage microorganisms in order to determine their behavior in the product; and thus whether those organisms present a risk to the microbial safety or quality of the product.

In some aspects, the detergent composition has a greater than 3 log reduction on day 7 in a micro challenge for bacterium. In some aspects, the detergent composition has a greater than 2 log reduction at 28 days in a microchallenge for bacterium. In some aspects, the detergent composition has a greater than 3 log reduction at 28 days in a microchallenge for bacterium. In some aspects, the detergent composition has a greater than 4 log reduction at 28 days in a microchallenge for bacterium. In some aspects, the detergent composition has a greater than 5 log reduction at 28 days in a microchallenge for bacterium. In some aspects, the detergent composition has a greater than 6 log reduction at 28 days in a microchallenge for bacterium.

In some aspects, the detergent composition has a greater than 1 log reduction at 14 days in a microchallenge for fungi with no growth observed afterwards. In some aspects, the detergent composition has a greater than 1 log reduction at 28 days in a microchallenge for fungi. In some aspects, the detergent composition has a greater than 2 log reduction at 28 days in a microchallenge for fungi. In some aspects, the detergent composition has a greater than 6 log reduction at 28 days in a microchallenge for fungi. In some aspects, the detergent composition has a greater than 1 log reduction on day 14 in a micro challenge for yeast and mold. In some aspects, the detergent composition has a greater than 1 log reduction on day 28 in a micro challenge for bacteria, yeast and mold.

In some aspects, the detergent composition reduces gram negative and gram positive bacteria to less than 10 CFU/g at 21 days. In some aspects, the detergent composition reduces gram negative and gram positive bacteria to less than 5 CFU/g at 21 days.

It was discovered that liquid detergent compositions with low pH were able to achieve self-preserving properties while maintaining mildness and good cleaning performance. In some aspects, the liquid detergent composition has a pH of less than 5. In some aspects, the detergent composition has a pH of less than 4.8, less than 4.5, less than 4.2, less than 4, less than 3.8, less than 3.5, less than 3, less than 2.8, or less than 2.5. In some aspects, the detergent composition has a pH of less than 5.

In some aspects, the detergent composition can have a pH of about 2 to about 5 (e.g., about 2 to about 4.5, about 2 to about 4, about 2 to about 3.5, about 2 to about 3, about 2 to about 2.5). In some aspects, the detergent composition has a pH of about 5, about 4.5, about 4, about 3.5, about 3, about 2.5, about 2.3, or about 2. In some aspects, the detergent composition has a pH of about 2 to about 4.5. In some aspects, the composition has a pH of about 2 to about 3.5. In some aspects, the detergent composition has a pH of about 4.5. In some aspects, the detergent composition has a pH of about 3.5. In some aspects, the detergent composition has a pH of about 3. In some aspects, the detergent composition has a pH of about 2.5. In some aspects, the detergent composition has a pH of about 2.3.

To help maintain the pH, in some aspects, the detergent composition can comprise an acid, which is any suitable compound with a pKa of less than about 10. In some aspects, the acid is an inorganic acid or an organic acid. In some aspects, the acid is a weak acid such that the acid has a pKa of 2 or greater (e.g., pKa is about 2 to about 10). Examples of a weak acid include, e.g., an organic acid or carbonic acidIn some aspects, the acid in the opaque liquid detergent composition is an organic acid, which in some instances can additionally act as a chelating agent. The organic acid can contain one or more (e.g., 1, 2, or 3) carboxylic acid groups, which can be used singly or in combination. In some aspects, the acid in the detergent composition is citric acid. In some aspects, the acid can be an acid solution (e.g., an acid in water). In some aspects, the detergent composition comprises an acid in any amount sufficient (q.s.) to achieve the desired pH.

In some aspects, the detergent composition comprises a base to adjust the pH. The base can be any suitable compound with a pKb of about 0.1 to about 13. In some aspects, the base can be monoethanolamine, diethanolamine, triethanolamine, methyl diethanolamine, a hydroxide, a tetraborate, a phosphate, a carbonate, a bicarbonate, or any combination thereof. The base can include a counterion, such as a Group I cation or Group II cation. In some aspects, the base is a Group I hydroxide, a Group II hydroxide, sodium tetraborate, trisodium phosphate, sodium carbonate, or a combination thereof. In some aspects, the base can be a monoethanolamine, sodium carbonate, or a Group I hydroxide (e.g., sodium hydroxide, potassium hydroxide, or a combination of both). In some aspects, the base can be a base solution (e.g., a base in water). In some aspects, the base in the detergent composition is sodium hydroxide. In some aspects, the base is a base solution (e.g., a 50% or 70% sodium hydroxide solution). In some aspects, the detergent composition comprises a base in any amount sufficient (q.s.) to achieve the desired pH.

In some aspects, the detergent composition comprises an acid and a base to form a buffer. The buffer can be any suitable composition that is water soluble and controls (i.e., maintains) the pH of the detergent composition within a pH of about 2 to about 5 (e.g., maintains a pH of about 5, about 4.5, about 4, about 3.5, about 3, about 2.5, or about 2.3). In some embodiments, the pH can be controlled to be within a range of about 2 to about 5 or a pH of about 4. In general, the buffer can comprise a weak acid and its conjugate base, a strong acid and a weak base, or a strong base and a weak acid. Examples of suitable acids and bases are described herein. In general, a strong acid will have a pKa of less than 2 and a weak acid will have a pKa of 2 or greater. In general, a strong base will have a pKb of less than 2 and a weak base will have a pKb of 2 or greater. For example, the buffer can comprise sodium hydroxide in combination with a weak acid, such as citric acid.

A water binding agent can used in an aqueous composition to reduce its water activity and improve the compositions self-preservation properties. Examples of the water binding agent include, but are not limited to, a salt, a saccharide, an organic solvent, and a mixture thereof.

A salt comprises a cation and an anion, and can be an inorganic salt or an organic salt. The cation can be inorganic or organic, such as sodium, calcium, potassium, magnesium, quaternary ammonium, pyridinium, tris(2-hydroxyethyl)methyl ammonium, or a mixture thereof. The anion can be inorganic or organic, such as a halide, phosphate, sulphate, formate, acetate, citrate, maleate, succinate, methylsulfate, and a mixture thereof.

In some aspects, the salt can be an ionic liquid, such as tris(2-hydroxyethyl)methyl ammonium methylsulfate. In some aspects, the salt is sodium chloride, sodium citrate, or sodium formate. In some aspects, the salt is sodium chloride (NaCl).

In some aspects, the detergent composition comprises from about 1 wt % to about 10 wt % of a salt (e.g., NaCl) relative to the total weight of the detergent composition. For example, the salt can be present in an amount from about 1 wt % to about 9 wt %, from about 1 wt % to about 8 wt %, about 1 wt % to about 7 wt %, from about 1 wt % to about 6 wt %, about 1 wt % to about 5 wt %, from about 1 wt % to about 4 wt %, from about 1 wt % to about 3 wt %, about 1 wt % to about 2 wt %, about 1 wt %, about 2 wt %, about 3 wt %, about 4 wt %, about 5 wt %, about 6 wt %, about 7 wt %, about 8 wt %, about 9 wt %, or about 10 wt % of the total weight of the detergent composition. In some aspects, the detergent composition comprises from about 2 wt % to about 10 wt % of a salt relative to the total weight of the detergent composition. In some aspects, the detergent composition comprises from about 2.5 wt % a salt relative to the total weight of the detergent composition. In some aspects, the detergent composition comprises from about 5 wt % a salt relative to the total weight of the detergent composition. In some aspects, the detergent composition comprises from about 7.5 wt % a salt relative to the total weight of the detergent composition. In some embodiments, the aqueous composition of the present disclosure is substantially free of a salt (e.g., NaCl).

In addition to water, the detergent composition can comprise a non-aqueous solvent. It was shown that the inclusion of a non-aqueous solvent was able to significantly improve the composition's self-preserving properties. In some aspects, the non-aqueous solvent comprises an alcohol (e.g., a C₁₄ alcohol), a polyol (e.g., a diol, a triol, or higher, such as polyethylene glycol), a glycol ether, or any combination thereof. Suitable examples of a solvent include, e.g., ethanol, ethylene glycol, diethylene glycol, triethylene glycol, diethylene glycol monobutyl ether, propylene glycol, dipropylene glycol, tripropylene glycol, dipropylene glycol monobutyl ether, 1,3-butylene glycol, 1,4-butylene glycol, 1-(1-butoxy-2-propoxy)-2-propanol, 2-methyl-2,4-pentanediol, 1,5-pentanediol, 1,6-hexanediol, polyethylene glycol, or any combination thereof.

In some aspects, the detergent composition comprises from about 1 wt % to about 10 wt % of a non-aqueous solvent (e.g., ethanol) relative to the total weight of the detergent composition. For example, the non-aqueous solvent can be present in an amount from about 1 wt % to about 9 wt %, from about 1 wt % to about 8 wt %, about 1 wt % to about 7 wt %, from about 1 wt % to about 6 wt %, about 1 wt % to about 5 wt %, about 1 wt % to about 4 wt %, about 1 wt % to about 3 wt %, about 1 wt % to about 2 wt %, about 1 wt %, about 2 wt %, about 3 wt %, about 4 wt %, about 5 wt %, about 6 wt %, about 7 wt %, about 8 wt %, about 9 wt %, or about 10 wt % of the total weight of the detergent composition. In some aspects, the detergent composition comprises from about 2 wt % to about 10 wt % of a non-aqueous solvent. In some aspects, the detergent composition comprises from about 2.5 wt % a non-aqueous solvent. In some aspects, the detergent composition comprises from about 5 wt % a non-aqueous solvent. In some aspects, the detergent composition comprises from about 7.5 wt % a non-aqueous solvent. In some aspects, the detergent composition is substantially free of a non-aqueous solvent.

In some aspects, the detergent composition has pH of less than 3 and is substantially free of NaCl and/or ethanol.

In some aspects the detergent composition comprises a fatty acid. In some aspects, the fatty acid is coconut fatty acid.

In some aspects, the detergent composition comprises from about 0.1 wt % to about 1.5 wt % of a fatty acid relative to the total weight of the detergent composition. For example, the fatty acid can be from about 0.1 wt % to about 1.4 wt %, about 0.1 wt % to about 1.3 wt %, about 0.1 wt % to about 1.2 wt %, about 0.1 wt % to about 1.1 wt %, about 0.1 wt % to about 1 wt %, about 0.1 wt % to about 0.9 wt %, about 0.1 wt % to about 0.8 wt %, about 0.1 wt % to about 0.7 wt %, about 0.1 wt % to about 0.6 wt %, about 0.1 wt % to about 0.5 wt %, about 0.1 wt % to about 0.4 wt %, about 0.1 wt % to about 0.3 wt %, about 0.1 wt % to about 0.2 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, or about 1.5 wt %, of the total weight of the detergent composition. In some aspects, the detergent composition comprises from about 0.1 to about 1.25 wt % of a fatty acid relative to the total weight of the detergent composition. In some aspects, the detergent composition comprises from about 0.1 to about 0.3 wt % of a fatty acid relative to the total weight of the detergent composition. In some aspects, the detergent composition comprises about 0.2 wt % to about 3 wt % of a fatty acid. In some aspects, the detergent composition comprises about 0.2 wt % of a fatty acid.

In some aspects, the detergent composition comprises a surfactant consisting essentially of an anionic surfactant, a nonionic surfactant, or a combination thereof. In some aspects, the surfactant consists essentially of a single anionic surfactant and a single nonionic surfactant. In some aspects, the single anionic surfactant and single non-ionic surfactant are present in a ratio of 1:2.

The anionic surfactant comprises a hydrophobic tail group (e.g., a linear aliphatic chain) and an anionic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl), alkyl, or fluoro (e.g., perfluorinated). The anionic hydrophilic group can be, for example, a sulfate (—OSO₃⁻), sulfonate (—SO₃⁻), a phosphate (—OPO₃³⁻), a carboxylate (—C(O)O⁻), or the conjugate base of an organic acid. In some aspects, polyethylene glycol repeat units designated as “ether” can be disposed between the hydrophobic tail group (e.g., a fatty group) and hydrophilic head group.

In some aspects, the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof. Typically, the salt will be a Group I (e.g., lithium, sodium, potassium, etc.).

Examples of an alkyl sulfate include, e.g., a fatty sulfate (e.g., octylsulfate, decyl sulfate, lauryl (dodecyl) sulfate, myristyl sulfate), dioctyl sodium sulfosuccinate, and an alkyl ether sulfate (AES)).

In some aspects, the anionic surfactant comprises an alkyl ether sulfate (AES). In general, the AES will have the structure R⁴—O-(EO)ₙSO₃⁻X⁺, in which R⁴ is a C₈-C₁₈ alkyl group (linear or branched), EO is polyethoxylate, n is typically 1 to 8 (e.g., 1, 2, 3, 4, 5, 6, 7, or 8), and X⁺ is a cation that balances the charge of the sulfonate. The C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₈ alkyl). In some aspects, the cation X⁺ can be a Group I cation, such as sodium cation or potassium cation, particularly sodium cation. In some aspects, the AES is sodium laureth sulfate. In some aspects, the AES is sodium laureth sulfate having three ethoxylate groups.

In some aspects, the detergent composition does not comprise a linear alkylbenzene sulfonate (LAS). LAS has the structure of Formula (I).

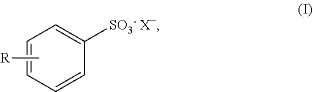

in which R is a linear C₁₀-C₁₈ (e.g., C₁₀, C₁₁, C₁₂, C₁₃, C₁₄, C₁₅, C₁₆, C₁₇, and C₁₈) alkyl, and X⁺ is a cation that balances the charge of the sulfonate. The phenylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some aspects, the alkyl R and sulfonate are para to one another. In some aspects, the liquid detergent composition comprises from about 1 wt % to about 10 wt % of an anionic surfactant (e.g., an alkyl ether sulfate (AES)), relative to the total weight of the detergent composition. For example, the total anionic surfactant content can be from about 1 wt % to about 9 wt %, about 1 wt % to about 8 wt %, about 1 wt % to about 7 wt %, about 1 wt % to about 6 wt %, about 1 wt % to about 5 wt %, about 1 wt % to about 4 wt %, about 1 wt % to about 3 wt %, about 1 wt % to about 2 wt %, about 10 wt %, about 9 wt %, about 8 wt %, about 7 wt %, about 6 wt %, about 5 wt %, about 4 wt %, about 3 wt %, about 2 wt %, or about 1 wt %, of the total weight of the detergent composition. In some aspects, the detergent composition comprises about 5 wt % to about 10 wt % of an anionic surfactant ((e.g., an alkyl ether sulfate (AES)). In some aspects, the detergent composition comprises about 5 wt % of an anionic surfactant. In some aspects, the detergent composition comprises about 6 wt % of an anionic surfactant. In some aspects, the detergent composition comprises about 7 wt % of an anionic surfactant. In some aspects, the detergent composition comprises at least 5.5 wt % of an anionic surfactant, wherein the detergent composition has a pH of 3.5.

A nonionic surfactant comprises a hydrophobic tail group (e.g., a linear aliphatic chain) and an uncharged (i.e., neutral) hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The uncharged hydrophilic group can be, for example, an alkoxylate, such as ethoxylate ((—CH₂CH₂O—)ₙ; EO or PEO) or propoxylate ((—CH(CH₃)CH₂O—)ₘ; PO or PPO), in which n and m are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

In some aspects, the nonionic surfactant comprises a methyl ester ethoxylate, an alcohol alkoxylate, a fatty acid alkoxylate, an alkyl phenol ethoxylate, an alkoxylated amine, an alkyl glucoside, a fatty amide alkoxylate, a diester of alkoxylated fatty acid, a glycerol fatty ester, castor oil alkoxylate, an ethylene oxide-propylene oxide block copolymer, a phenol alkoxylate, or a combination thereof.

Examples of an alcohol alkoxylate include, e.g., C₈-C₁₈ ethoxylate and C₈-C₁₈ propoxylate.

In general, the alcohol ethoxylate (AE) will have a chemical structure of formula (I):

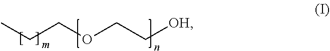

in which m is an integer of 10 to 16 (e.g., 10, 11, 12, 13, 14, 15, or 16) to form a C₁₂-C₁₈ fatty alkyl (e.g., C₁₂, C₁₃, C₁₄, C₁₅, C₁₆, C₁₇, and C₁₈), and n is an integer of 1 to 15 (e.g., 1, 2, 3, 4, 5, 6, 7, 8, 9, 10, 11, 12, 13, 14, or 15). The alcohol ethoxylate typically will contain a range of alkyl groups, such as C₁₂-C₁₅ or C₁₂-C₁₄ and can contain branches. In some aspects, the fatty alcohol ethoxylate can contain 1 to 15 moles (e.g., 1 to 12 moles, 1 to 9 moles, 1 to 7 moles, or about 7 moles) of ethoxylate per mole of alcohol. In some aspects, the fatty alcohol ethoxylate can be a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate. In some aspects, the alcohol ethoxylate comprises ethoxylated lauryl alcohol. In some aspects, the alcohol ethoxylate comprises ethoxylated lauryl alcohol with 7 moles of ethoxylate.

In some aspects, the liquid detergent composition comprises from about 5 wt % to about 20 wt % of a nonionic surfactant (e.g., an alcohol ethoxylate (AE)), relative to the total weight of the detergent composition. For example, the total non-ionic surfactant content can be from about 5 wt % to about 19 wt %, about 5 wt % to about 18 wt %, about 5 wt % to about 17 wt %, about 5 wt % to about 16 wt %, about 5 wt % to about 15 wt %, about 5 wt % to about 14 wt %, about 5 wt % to about 13 wt %, about 5 wt % to about 12 wt %, about 5 wt % to about 11 wt %, about 5 wt % to about 10 wt % about 5 wt % to about 9 wt %, about 5 wt % to about 8 wt %, about 5 wt % to about 7 wt %, about 5 wt % to about 6 wt %, about 20 wt %, about 19 wt %, about 18 wt %, about 17 wt %, about 16 wt %, about 15 wt %, about 14 wt %, about 13 wt %, about 12 wt %, about 11 wt %, about 10 wt %, about 9 wt %, about 8 wt %, about 7 wt %, about 6 wt % or about 5 wt %, of the total weight of the detergent composition. In some aspects, the detergent composition comprises about 5 to about 20 wt % of a non-ionic surfactant. In some aspects, the detergent composition comprises about 5 to about 15 wt % of a non-ionic surfactant (e.g., a non-ionic alcohol ethoxylate (AE)). In some aspects, the detergent composition comprises about 11 wt % of a non-ionic surfactant. In some aspects, the detergent composition comprises about 10 wt % of a non-ionic surfactant.

In some aspects, the detergent composition comprises a single non-ionic surfactant and a single anionic surfactant. In some aspects, the detergent composition comprises an alcohol ethoxylate (AE) and an alkyl ether sulfate (AES). In some of these aspects, the detergent composition comprises an alcohol ethoxylate (AE), an alkyl ether sulfate (AES) and does not comprise (e.g., is substantially free of) a linear alkylbenzene sulfonate.

The detergent composition comprises a surfactant consisting essentially of from about 10 wt % to about 30 wt % of a combination of an anionic and non-ionic surfactant relative to the total weight of the detergent composition. For example, the total surfactant content can be from about 10 wt % to about 28 wt %, about 10 wt % to about 25 wt %, about 10 wt % to about 22 wt %, about 10 wt % to about 20 wt %, about 10 wt % to about 15 wt %, about 12 wt % to about 30 wt %, about 12 wt % to about 28 wt %, about 12 wt % to about 25 wt %, about 12 wt % to about 20 wt %, about 12 wt % to about 15 wt %, about 15 wt % to about 30 wt %, about 15 wt % to about 28 wt %, about 15 wt % to about 25 wt %, about 15 wt % to about 20 wt %, about 18 wt % to about 30 wt %, about 18 wt % to about 28 wt %, about 18 wt % to about 25 wt %, about 18 wt % to about 20 wt %, about 20 wt % to about 30 wt %, about 20 wt % to about 28 wt %, about 20 wt % to about 25 wt %, about 30 wt %, about 25 wt %, about 20 wt %, about 19 wt %, about 18 wt %, about 17 wt %, about 16 wt %, about 15 wt %, about 14 wt %, about 13 wt %, about 12 wt %, about 11 wt %, or about 10 wt % of the total weight of the detergent composition. In some aspects, the detergent composition comprises a surfactant consisting essentially of about 15 to about 25 wt % of an anionic and non-ionic surfactant. In some aspects, the detergent composition comprises a surfactant consisting essentially of about 15 to about 20 wt % of an anionic and non-ionic surfactant. In some aspects, the detergent composition comprises a surfactant consisting essentially of about 17 wt % of an anionic and non-ionic surfactant. In some aspects, the detergent composition comprises a surfactant consisting essentially of about 17 wt % of a single anionic and a single non-ionic surfactant.

In some aspects, the detergent composition comprises more nonionic surfactant than anionic surfactant. In some aspects the nonionic surfactant and anionic surfactant are present in a ratio of about 1:1 to about 2:1. In some aspects, the nonionic surfactant and anionic surfactant are present in a ratio of 2:1.

In some aspects, the detergent composition comprises an anti-redeposition agent that keeps dissolved soil stains stable in the wash water and prevent the stains from redepositing on a textile. In some aspects, the anti-redeposition agent is a biodegradable polymer. The anti-redeposition agent (e.g., anti-redeposition polymer) can be based on acrylic acid, e.g., a homopolymer of acrylic acid, a polycarboxylate based on acrylic acid, a copolymer of acrylic acid and polystyrene, or a copolymer of maleic acid and acrylic acid. Examples of a suitable anti-redeposition agent include, e.g., sodium polyacrylate, modified polyethylene glycol, styrene-acrylic acid copolymer, polyethyleneimine, or a combination thereof. In some aspects, the anti-redeposition agent comprises sodium polyacrylate.

In some aspects, the detergent composition comprises from about 0.1 wt % to about 1 wt % of an anti-redeposition agent relative to the total weight of the detergent composition. For example, the anti-redeposition agent can be present in an amount from about 0.1 wt % to about 1 wt %, about 0.2 wt % to about 1 wt %, about 0.3 wt % to about 1 wt %, about 0.4 wt % to about 1 wt %, about 0.5 wt % to about 1 wt %, about 0.6 wt % to about 1 wt %, about 0.7 wt % to about 1 wt %, about 0.8 wt % to about 1 wt %, about 0.9 wt % to about 1 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt %, of the total weight of the detergent composition. In some aspects, the detergent composition comprises a polymer (e.g., an anti-redeposition polymer). In some aspects, the detergent composition comprises from about 0.1 wt % to about 0.5 wt % of an anti-redeposition polymer (e.g., homopolymer of acrylic acid or a copolymer of acrylic acid and polystyrene). In some aspects, the detergent composition comprises from about 0.1 wt % to about 0.3 wt % of an anti-redeposition polymer (e.g., homopolymer of acrylic acid or a copolymer of acrylic acid and polystyrene).

In some aspects, the detergent composition comprises a chelating agent (i.e., a chelant) that serves to improve the cleaning action of the detergent by scavenging metal ions naturally found in water. Suitable examples of a chelating agent includes, e.g., methylglycinediacetic acid (MGDA), citric acid, oxalic acid, nitriloacetic acid, phosphoric acid, polyphosphoric acid (e.g., a polyphosphate, such as tripolyphosphate), a phosphonate, ethylenediaminetetraacetic acid, diethylenetriaminepentaacetic acid (pentetic acid), hydroxyethylethylenediaminetriacetic acid, ethylenediamine-N,N′-disuccinic acid (EDDS), glutamic acid, aspartic acid, iminodisuccinic acid, any salt thereof (e.g., sodium citrate, disodium edetate, tetrasodium glutamate diacetate, tetrasodium aspartate diacetate, tetrasodium iminodisuccinate (IDS)), or any combination thereof. In some aspects, the detergent composition comprises tetrasodium iminodisuccinate (IDS), ethylenediamine-N,N′-disuccinic acid (EDDS), methylglycinediacetic acid (MGDA), or any combination thereof. In some aspects, the detergent composition comprises methylglycinediacetic acid (MGDA).

In some aspects, the detergent composition comprises from about 0.1 wt % to about 1 wt % of a chelating agent relative to the total weight of the detergent composition. For example, the chelating agent can be present in an amount from about 0.1 wt % to about 1 wt %, about 0.2 wt % to about 1 wt %, about 0.3 wt % to about 1 wt %, about 0.4 wt % to about 1 wt %, about 0.5 wt % to about 1 wt %, about 0.6 wt % to about 1 wt %, about 0.7 wt % to about 1 wt %, about 0.8 wt % to about 1 wt %, about 0.9 wt % to about 1 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt %, of the total weight of the detergent composition. In some aspects, the detergent composition comprises from about 0.1 wt % to about 0.9 wt % of a chelating agent (e.g., methylglycinediacetic acid (MGDA)). In some aspects, the detergent composition comprises about 0.4 wt % of a chelating agent. In some aspects, the detergent composition comprises about 1 wt % of a chelating agent.

In some aspects, the detergent composition comprises a polymer and a chelant. In some aspects, the detergent composition comprises about 0.5 to about 2 wt % of a polymer and a chelant. In some aspects, the detergent composition comprises about 0.5 to about 1 wt % of a polymer and a chelant.

In some aspects, the detergent composition further comprises at least one additive. For example, the at least one additive can be selected from an acid, a base, an amino acid, a chlorine scavenger, an optical brightener, a fragrance, one or more enzymes, a corrosion inhibitor, and any combination thereof.

In some aspects, the detergent composition comprises from about 1 wt % to about 20 wt % of a total amount of additives relative to the total weight of the detergent composition. For example, the total amount of additives can be from about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 1.5 wt % to about 20 wt %, about 1.5 wt % to about 18 wt %, about 1.5 wt % to about 15 wt %, about 1.5 wt % to about 12 wt %, about 1.5 wt % to about 10 wt %, about 1.5 wt % to about 8 wt %, about 1.5 wt % to about 5 wt %, about 1.5 wt % to about 3 wt %, about 2 wt % to about 20 wt %, about 2 wt % to about 18 wt %, about 2 wt % to about 15 wt %, about 2 wt % to about 12 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, about 14.5 wt %, about 15 wt %, about 15.5 wt %, about 16 wt %, about 16.5 wt %, about 17 wt %, about 17.5 wt %, about 18 wt %, about 18.5 wt %, about 19 wt %, about 19.5 wt %, or about 20 wt % of the total weight of the detergent composition.

In some aspects, the detergent composition comprises an enzyme to aid in removing stains, including protein stains, oil stains, tannin stains, starch stains, and dyes. For example, a protease is capable of breaking down protein-based stains, such as sweat, blood, mud, and dairy products.

In some aspects, the detergent composition comprises a chlorine scavenger. The chlorine scavenger is any compound that can react with chlorine or a chlorine-generating compound (e.g., hypochlorite) to eliminate or reduce the bleaching activity. In some aspects, the chlorine scavenger can also act as a corrosion inhibitor.

In some aspects, the detergent composition comprises an optical brightener (e.g., a fluorescent whitening agent), which is any suitable hydrophilic compound that absorbs ultra violet light and emits visible (e.g., blue-violet) light to make textiles appear brighter.

In some aspects, the detergent composition comprises a corrosion inhibitor (e.g., an oxygen scavenger), which is any suitable compound that lowers the dissolved oxygen content in the washing medium by reacting with oxygen. The corrosion inhibitor can, for example, protect the inside of a washing machine from rusting.

In some aspects, the detergent composition comprises at least one enzyme, an acid and a base, and an optical brightener. In some aspects, the detergent composition comprises an acid and a base, and at least one enzyme (e.g., protease, amylase, mannanase, or any combination thereof) as additives. In some aspects, the detergent composition comprises an amino acid, a sulfite and at least one enzyme as additives.

In some aspects, the detergent composition comprises water, a surfactant, a fatty acid, a polymer, and a chelant, wherein the surfactant consists essentially of a single anionic surfactant and a single non-ionic surfactant, wherein the composition does not comprise a preservative, wherein the detergent composition has a pH of less than 5, and wherein the detergent composition has a Zein score of not more than about 2% dissolved zein when tested on a 10% dilution.

In some aspects, the detergent composition comprises water, about 10 to about 20 wt % of a non-ionic and anionic surfactant, about 0.1 to about 0.5 wt % of a fatty acid, and about 0.5 to about 2 wt % of polymer and a chelant, wherein the composition does not comprise a preservative, wherein the detergent composition has a pH of less than 5, and wherein the detergent composition has a Zein score of not more than about 2% dissolved zein when tested on a 10% dilution.

In some aspects, the detergent composition comprises water, about 10 to about 20 wt % of a non-ionic and anionic surfactant, about 0.1 to about 0.5 wt % of a fatty acid, about 0.5 to about 2 wt % of polymer and a chelant, and about 10 wt % of a non-aqueous solvent and a salt, wherein the composition does not comprise a preservative, wherein the detergent composition has a pH of less than 5, and wherein the detergent composition has a Zein score of not more than about 2% dissolved zein when tested on a 10% dilution.

In some aspects, the detergent composition comprises water, about 5 to about 20 wt % of a non-ionic surfactant, about 1 wt % to about 10 wt % of an anionic surfactant, about 0.1 to about 1.25 wt % of a fatty acid, and about 0.1 to about 1 wt % of polymer and a chelant, wherein the composition does not comprise a preservative, wherein the detergent composition has a pH of less than 4, and wherein the detergent composition has a Zein score of not more than about 2% dissolved zein when tested on a 10% dilution.

In some aspects, the detergent composition comprises water, about 15 to about 20 wt % of a non-ionic and anionic surfactant, about 0.1 to about 0.5 wt % of a fatty acid, and about 0.1 to about 1 wt % of polymer and a chelant, wherein the composition does not comprise a preservative, wherein the detergent composition has a pH of less than 4, and wherein the detergent composition has a Zein score of not more than about 2% dissolved zein when tested on a 10% dilution.

In some aspects, the detergent composition comprises water, about 15 to about 25 wt % of a surfactant, about 0.1 to about 1.25 wt % of a fatty acid, about 0.5 to about 2 wt % of a polymer and a chelant, and optionally, about 2 to about 12 wt % of at least one ingredient selected from the group consisting of ethanol and NaCl, wherein the surfactant consists essentially of a single anionic surfactant and a single non-ionic surfactant, wherein the detergent composition does not comprise a preservative, wherein the detergent composition has a pH of less than 5, and wherein the detergent composition has a Zein score of not more than about 2% dissolved zein when tested on a 10% dilution.

In some aspects, the detergent composition comprises water, about 10 to about 20 wt % of a non-ionic alcohol ethoxylate and an alkyl ether sulfate, about 0.2 to about 0.3 wt % of a fatty acid, about 0.5 to about 1 wt % of a polymer and a chelant, citric acid and sodium hydroxide, and optionally, about 2 to about 12 wt % of at least one ingredient selected from the group consisting of ethanol and NaCl, wherein the detergent composition does not comprise a preservative, wherein the detergent composition has a pH of about 2 to about 4.5, and wherein the detergent composition has a Zein score of not more than about 2% dissolved zein when tested on a 10% dilution.

In some aspects, the detergent composition is a liquid, including a liquid that is dispensed from a container upon use.

In some aspects, the present disclosure is directed to a method of using the detergent composition of any of the foregoing aspects. For example, the detergent composition can be used in a method of removing soil from a textile (e.g., cleaning a textile, such as a fabric). In particular, the present disclosure is directed to a method of removing soil from a textile comprising contacting the textile with a composition comprising the detergent composition described herein and water to form a washing load. Optional steps include mixing (e.g., agitating) the washing load and composition, removing the composition to provide a clean textile, rinsing the clean textile with additional water, and isolating the clean textile. In some aspects, soils that are suitably removed using the unit dose product include, but are not limited to, oil-containing soils, carbohydrate-containing soils, protein-containing soils, tannin-containing soils, particulate soils, and any combination thereof.

In some aspects of these methods, the method can be performed using a washing machine, a tergotometer, or an equivalent device. In some aspects of these methods, the water is hot or warm water (e.g., about 21-35° C., about 22-32° C., about 25-35° C., about 25-32° C., about 28-35° C., about 30-35° C., or about 32° C.). In some aspects of these methods, the water is cold water (e.g., about 5-20° C., about 12-16° C., or about 15° C.).

In an aspect, the method is directed to providing a mild detergent composition.

In an aspect, the method is directed to providing an allergen-free detergent composition.

In an aspect, the method is directed to providing detergent compositions comprising Safer Choice ingredients.

### EXAMPLES

These examples are provided for the purpose of illustration only and the embodiments described herein should in no way be construed as being limited to these examples. Rather, the embodiments should be construed to encompass any and all variations which become evident as a result of the teaching provided herein.

### Example 1 (Micro Challenges)

A base detergent composition (Base Formulation 1) was prepared with the components listed in Table 1. Formulation 1 was post dosed with citric acid and/or sodium hydroxide to match a target pH ranging from 2.33 to 4.5, resulting in Formulations 1A-F. Micro challenges were then run on the resulting compositions (Formulations 1A-F) for log reduction rates of bacteria and fungi.

Bacteria were double challenged (inoculated about 1E08 to 1E09 CFU/g) and fungi (inoculated about 1E8 to 5E8) was single challenged. A. brasiliensis (mold), S. aureus, E. coli, P. gergoviae/B. cepecia mixture, P. aeruginosa, C. albicans, H. venusta were tested. Pass criteria for bacterium is greater than 3 log reduction on day 7, and 4 logs on day 28. Pass criteria for fungi is greater than 1 log reduction at and after 14 days. The results of the micro challenges for each of Formulations 1A-F are shown below in Table 2.

TABLE 1
Base Formulation 1.

| Material | % |
|---|---|
| Water | QS to 50 |
| pH adjusters | As needed to hit |
| (Citric Acid or Sodium Hydroxide) | desired pH |
| Alcohol Ethoxylate Surfactant, C12-C15 7EO | 17.3 (2:1 ratio) |
| and SLES, 3 EO (70% active) | |
| Fatty Acid | 0.25 |
| Polymer and Chelant | 0.585 |

SLES: sodium lauryl ether sulfate
EO: ethoxylate

TABLE 2
Micro challenges

| | | Bacteria | Yeast | Mold |
|---|---|---|---|---|
| Formula | pH | (Day 28) | (Day 28) | (Day 28) |
| 1A | 2.33 | PASS | PASS | PASS |
| | | (6 log reduction) | (6 log reduction) | (6 log reduction) |
| 1B | 2.5 | PASS | PASS | PASS |
| | | (6 log reduction) | (6 log reduction) | (6 log reduction) |
| 1C | 3 | PASS | PASS | PASS |
| | | (6 log reduction) | (6 log reduction) | (1.7 log reduction) |
| 1D | 3.5 | PASS | PASS | PASS |
| | | (6 log reduction) | (2.5 log reduction) | (1.35 log |
| | | | | reduction) |
| 1E | 4 | PASS | PASS | FAIL |
| | | (6 log reduction) | (1.3 log reduction) | (0 log reduction) |
| 1F | 4.5 | PASS | FAIL | PASS |
| | | (6 log reduction) | (0.8 log reduction) | (1.1 log reduction) |

As shown in Table 2, all formulas with a pH of 2.33 to 3.5 (Formulas 1A-D), passed against bacteria, yeast and mold. Formula 1E (pH 4) failed against mold and Formula 1F (pH 4.5) failed against yeast. All samples had a 1 log reduction against yeast and mold at Day 14.

For bacteria, all samples saw reduction to the detection limit (less than 5 CFU/g) for gram negative (E. coli, P. gergoviae/B. cepecia mixture, P. aeruginosa, H. venusta) and gram positive bacteria (S. aureus).

### Example 2 (Surfactants)

Base Formulation 2 was prepared with the components as shown in Table 3 and pH adjusted to a target pH of 3.5. Various ratios of anionic and nonionic surfactant were used to fill the 16.92% surfactant hole in base Formulation 2, resulting in Formulations 2A-F, as shown in Table 4. Formulations 2A-F were then tested to determine if mold/yeast could grow spontaneously after storing the compositions at 25° C. for two weeks.

TABLE 3
Base Formulation 2

| Material | % |
|---|---|
| Water | QS to 50 |
| pH adjusters | As |
| (citric acid or sodium hydroxide) | needed |
| Fatty Acid | 0.23 |
| Polymer and Chelant | 0.59 |
| Surfactant Hole | 16.92 |

TABLE 4
Ratios of surfactant to fill 16.92% hole

| | | Alcohol | |
|---|---|---|---|
| Formulation | SLES | Ethoxylate | Pass/Fail |
| 2A | 5.64 | 11.28 | Pass |
| 2B | 2.57 | 14.36 | Fail |
| 2C | 7.05 | 9.87 | Pass |
| 2D | 4.23 | 12.69 | Fail |
| 2E | 2.82 | 14.91 | Fail |
| 2F | 1.41 | 15.51 | Fail |

SLES: Sodium lauryl ether sulfate, 3 moles of ethoxylate (70% active)

As shown in Table 4, Formulations 2A and 2C passed initial micro stability as no spontaneous growth of mold and/or yeast was observed. Formulations 2B, 2D, 2E, and 2F all failed due to observed growth of mold and/or yeast. The results show that at a pH 3.5, a critical limit of SLES is needed in order to stabilize the product against spontaneous mold/yeast growth. This appears to be around 5.64% SLES in the blend of 16.92% total surfactant.

### Example 3 (Solvent and Salt)

Eleven formulations were prepared using Base Formulation 3 with the components listed in Table 4 and then pH adjusted to 4.5. Various ratios of ethanol, salt, and water were then post dosed to fill the 20% hole, resulting in Formulations 3A-K, shown in Table 5.

TABLE 4
Base Formulation 3

| Material | % |
|---|---|
| Water | QS to 50 |
| pH adjusters | As |
| (Citric Acid or Sodium Hydroxide) | needed |
| Alcohol Ethoxylate Surfactant, C12-C15 7EO | about 20 |
| and SLES, 3EO (70% active) | |
| Fatty Acid | 0.23 |
| Polymer and Chelant | 1.45 |
| Hole | 20 |

SLES: sodium lauryl ether sulfate
EO: ethoxylate

TABLE 5

| | Ratios of post-dosed materials to | | |
|---|---|---|---|
| | 20% hole | | |
| Formulation | Ethanol | NaCl | Water |
| 3A | 0.125 | 0.375 | 0.5 |
| 3B | 0.25 | 0.25 | 0.5 |
| 3C | 0 | 0 | 1 |
| 3D | 0.5 | 0 | 0.5 |
| 3E | 0.375 | 0.125 | 0.5 |
| 3F | 0.5 | 0.5 | 0 |
| 3G | 0 | 0.5 | 0.5 |
| 3H | 0.125 | 0.125 | 0.75 |
| 3I | 0.375 | 0.375 | 0.25 |
| 3J | 0.25 | 0.375 | 0.375 |
| 3K | 0.375 | 0.25 | 0.375 |

Formulations 3A-K were then tested for mildness, mold reduction, and viscosity. As shown in Table 6 below, each of Formulations 3A, 3C, 3E-F, and 3H-J were considered mild with a Zein score below 1% (Zein score below 2 being the standard for a mild detergent).

TABLE 6

| | | | Mold | |
|---|---|---|---|---|
| | Zein | Zein | Reduction in | Viscosity |
| Formulation | Score 1 | Score 2 | Log at Day 35 | cP at 25 C. |
| 3A | 0.33 | 0.34 | 0.9 | 1452 |
| 3B | DNT | DNT | 0.7 | 1181 |
| 3C | 0.42 | 0.42 | DNT | 76 |
| | | | (spontaneous | |
| | | | growth before | |
| | | | testing) | |
| 3D | DNT | DNT | 1.82 | 24 |
| 3E | 0.38 | 0.38 | 1.2 | 260 |
| 3F | 0.3 | 0.33 | 2 | 290 |
| 3G | DNT | DNT | 0.83 | 373 |
| 3H | 0.31 | No | DNT | 1283 |
| | | replicate | (spontaneous | |
| | | tested | growth before | |
| | | | testing) | |
| 3I | 0.32 | 0.37 | 1.3 | 594 |
| 3J | 0.37 | 0.41 | 0.87 | 515 |
| 3K | DNT | DNT | 1.2 | 588 |

The estimated regression coefficients for mold reduction of Formulations 3A-K was then analyzed in Minitab, and the p value indicated significance (below 0.05).

The estimated regression coefficients showed that ethanol and salt provide a self-preservation benefit (vs. water), as the multipliers are 2.771 and 0.909, respectively versus water's multiplier of 0.2.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A liquid detergent composition comprising
i. water;
ii. about 15 to about 25 wt % of surfactant;
iii. about 0.1 to about 1.25 wt % of a fatty acid;
iv. about 0.5 to about 2 wt % of a polymer and chelant; and
v. optionally about 2 to about 12 wt % of at least one ingredient selected from the group consisting of ethanol and NaCl,
wherein the surfactant consists essentially of a single anionic surfactant and a single non-ionic surfactant,
wherein the detergent composition does not comprise a preservative,
wherein the detergent composition has a pH of less than 5, and
wherein the detergent composition has a Zein score of not more than about 2% dissolved zein when tested on a 10% dilution.

2. The detergent composition of claim 1, wherein the composition has a pH of about 2 to about 4.5.

3. The detergent composition of claim 2, wherein the single anionic surfactant is present in an amount of about 5 wt % to about 8 wt % and the single non-ionic surfactant is present in an amount of about 10 wt % to about 12 wt %.

4. The detergent composition of claim 3, wherein the single anionic surfactant and single non-ionic surfactant are present in an amount ratio of 1:2.

5. The detergent composition of claim 1, wherein the single anionic surfactant is an alkyl ether sulfate.

6. The detergent composition of claim 5, wherein alkyl ether sulfate is lauryl ether sulfate.

7. The detergent composition of claim 1, wherein the single non-ionic surfactant is an alcohol ethoxylate.

8. The detergent composition of claim 7, wherein the non-ionic alcohol ethoxylate comprises the formula R¹-(EO)ₙ—OH, wherein R¹ is a C₁₂-C₁₈ alkyl group, EO is ethoxylate, and n is an integer of moles from 1 to 15.

9. The detergent composition of claim 1, wherein the detergent composition comprises about 2 to about 5 wt % of ethanol.

10. The detergent composition of claim 9, wherein the detergent composition comprises about 2 to about 5 wt % of NaCl.

11. The detergent composition of claim 1, wherein the polymer is selected from a polyethyleneimine alkoxylate, a methylacrylate styrene copolymer, an acrylic acid polymer, and combinations thereof.

12. The detergent composition of claim 1, wherein the chelant is methylglycinediacetic acid (MGDA).

13. The detergent composition of claim 1, wherein the detergent composition further comprises at least one additive selected from an acid, a base, an amino acid, a chlorine scavenger, an optical brightener, a fragrance, one or more enzymes, a corrosion inhibitor, and combinations thereof.

14. The detergent composition of claim 13, wherein the detergent composition comprises an acid and a base to form a buffer.

15. The detergent composition of claim 14, wherein the acid is citric acid and the base is NaOH.

16. The detergent composition of claim 1, wherein the detergent composition has a Zein score of not more than about 1% dissolved zein when tested on a 10% dilution.

17. The detergent composition of claim 1, wherein the detergent composition has a greater than 1 log reduction on day 14 in a micro challenge for yeast and mold.

18. The detergent composition of claim 3, wherein the detergent composition has a greater than 1 log reduction on day 28 in a micro challenge for bacteria, yeast and mold.

19. The detergent composition of claim 1, wherein the detergent composition has a viscosity of about 200 to about 1500 cP at 25° C.

20. The detergent composition of claim 1, comprising about 15 to about 20 wt % of a non-ionic alcohol ethoxylate and an alkyl ether sulfate;
about 0.2 to about 0.3 wt % of fatty acid;
about 0.5 to about 1 wt % of a polymer and chelant; and
citric acid;
wherein the detergent composition has a pH of about 2 to about 4.5.
